(19) United States
(12) Patent Application Publication
(10) Pub. No.: US 2005/0094754 A1
(43) Pub. Date: May 5, 2005

(54) Data regeneration apparatus

(75) Inventor: Orimitsu Serizawa, Gyouda-Shi (JP)

Correspondence Address: OSHA & MAY L.L.P., 1221 MCKINNEY STREET, SUITE 2800, HOUSTON, TX, 77010, US

(73) Assignee: Sanyo Electric Co., Ltd., Osaka (JP)

(21) Appl. No.: 10/976,295

(22) Filed: Oct. 27, 2004

(30) Foreign Application Priority Data
Oct. 31, 2003 (JP) 2003-373523

(51) Int. Cl. H04B 1/10

(52) U.S. Cl. 375/350; 375/355

(57) ABSTRACT

An apparatus for generating digital data. A signal regenerated by a playback head is sequentially processed by an analog filter, A/D, and an interpolator, and is provided to a digital equalizer. The digital equalizer has a plurality of variable filters connected in parallel. While the characteristic of the first variable filter is adjusted, the interpolator performs timing control using the output of the second variable filter. After the adjustment is completed, the switch SW is switched to perform timing control of the interpolator using the output of the first variable filter.

### CROSS-REFERENCE TO RELATED APPLICATIONS

The priority Japanese Patent Application Number 2003-373523 upon which this patent application is based is hereby incorporated by reference.

### FIELD OF THE INVENTION

The present invention generally relates to a data regeneration apparatus, and more particularly to an equalizing process on a digital data regenerated signal and timing control.

### RELATED ART

Conventionally, technology for regenerating a digital video signal and a digital audio signal recorded on a magnetic tape, etc. is widely known. The apparatus of this type compensates for the characteristic variance depending on the degradation of a signal and the type of magnetic tape in a recording regeneration system, etc. by an equalizer equalizing a regenerated signal, thereby reducing error.

FIG. 12 is a block diagram of the configuration of a regeneration apparatus having an equalizer. A regeneration circuit 103 is configured by a rotary magnetic head, regenerates information such as an video signal, an audio signal, a subcode, etc. from the track of a magnetic tape 101, and outputs them as analog signals. An amplifier 105 amplifies a regenerated signal from the rotary head, and outputs the resultant signal to an equalizer 107.

The equalizer 107 has a high frequency emphatic filter (enhancing filter), an all pass filter for controlling the group delay of a low frequency, and an all pass filter for controlling the group delay of a high frequency. The high frequency emphatic filter compensates for the degradation of the high frequency component of a signal from the amplifier 105, and outputs the resultant signal to the all pass filter for low frequency group delay control. The all pass filter for low frequency group delay control adjusts the group delay of a low frequency of an analog regenerated signal for compensation of the dipulse characteristic of the magnetic tape, and outputs the result to the all pass filter for high frequency group delay control. The all pass filter of the high frequency group delay control controls the group delay of the high frequency of the analog regenerated signal, and further performs an integral process and outputs the result to an A/D 109.

The A/D 109 converts the analog regenerated signal from the equalizer 107 into a digital signal, and outputs the digital signal to an FIR filter 111 and a PLL 113. The A/D 109 samples the analog regenerated signal according to the clock from the PLL 113.

The FIR filter 111 has a plurality of latches and coefficient units, adjusts the group delay characteristic, and outputs the result to a PR4 decoder 115. The PR4 decoder 115 demodulates the digital signal treated in PR4 pre-coding process and stored, and outputs the result to an evaluation circuit 117 and a Viterbi decoder 121. The evaluation circuit 117 evaluates the characteristic of the equalizer 107, outputs the result to an equalizer control circuit 119, and adjusts the characteristic of the equalizer 107. The Viterbi decoder 121 detects the digital signal of one bit per sample from the output of the PR4 decoder 115 using the Viterbi algorithm, and outputs the signal to a signal processing circuit 123. The signal processing circuit 123 obtains a regenerated image signal and a regenerated audio signal according to the digital signal obtained by the Viterbi decoder 121, and outputs them through an output terminal 125. Japanese Patent Laid-open Publication No. 2001-209902 discloses an example of a regeneration apparatus.

Thus, in the conventional regeneration apparatus, the equalizer 107 performs the equalizing process on the analog regenerated signal obtained by the regeneration circuit 103, and can adjust the characteristic variance to a certain extent, but there are restrictions on a wider range of characteristic variance or on an error reducing method. Particularly, there are various magnetic tapes and magnetic heads with their characteristic variances increased, and additionally the stability in performance, the flexibility in supporting various requests, and the request to reduce cost require variable adjustments of the equalization characteristic of an equalizer with flexibility and high precision.

On the other hand, when the apparatus is configured to variably adjust the equalization characteristic of an equalizer, there can be the problem that timing control is very difficult. That is, for example, if a signal is converted to a digital signal in asynchronous sampling (a regenerated signal is sampled using a clock asynchronous to the symbol), then it is necessary for an interpolator to interpolate data to estimate symbol point data between sample points, thereby feedback-controlling the interpolation timing based on the output of the equalization means, and realizing optimization. However, if the filter characteristic of the equalization means is changed, the interpolation timing is also simultaneously changed, thereby causing a difficult adjustment.

### SUMMARY OF THE INVENTION

It is an advantage of the present invention to provide a data regeneration apparatus capable of performing an equalizing process on a regenerated signal more flexibly and with high precision, and reducing regeneration errors since timing is controlled easily.

The data regeneration apparatus according to the present invention includes: regeneration means for regenerating digital data; analog-to-digital conversion means for converting an analog signal from the regeneration means to a digital signal; interpolation means for interpolating a digital signal from the analog-to-digital conversion means; digital equalization means for equalizing a digital signal from the interpolation means to a desired target characteristic; and timing adjustment means for adjusting interpolation timing in the interpolation means according to the digital signal from the digital equalization means. With this configuration, the digital equalization means includes a plurality of variable filter means connected parallel to each other, and switch means for switching and outputting the output of the plurality of variable filter means selectively to the timing adjustment means.

The digital signal equalized by the equalization means is provided for the timing adjustment means and feedback-controlled, thereby optimizing (synchronizing) the interpolation timing by the interpolation means. In the present invention, the digital equalization means have a plurality of variable filter means connected parallel to each other, and output of any variable filter means is selectively provided for the timing adjustment means. Therefore, it is necessary to change the equalization characteristic of the digital equalization means by the characteristic variance of the record medium of digital data, etc. Therefore, when the filter characteristic of any of the variable filter means is adjusted, it becomes possible to provide the output of the other variable filter means whose filter characteristics are not changed for the timing adjustment means. Thus, while a filter characteristic is adjusted, the synchronization by the timing adjustment means is not changed, and the adjustment of the filter characteristic of the variable filter means can be made with the synchronization established, thereby easily realizing the adjustment. According to the present invention, by arranging a plurality of variable filter means connected parallel to each other, a timing adjustment and a filter characteristic adjustment can be made separately, and each adjustment can be made individually.

In an embodiment of the present invention, a plurality of variable filter means include a first variable filter means and a second variable filter means, and the switch means outputs the output of the first variable filter to the timing adjustment means while the second variable filter is being filter characteristic adjusted, and outputs the output of the second variable filter to the timing adjustment means after the filter characteristic adjustment of the second variable filter is completed. The first variable filter means are a variable filter which maintains its filter characteristic, and the second variable filter means are a variable filter which adjust its filter characteristic.

The present invention can be clearly understood by referring to the following embodiments. However, the scope of the present invention is not limited to the following embodiments.

### BRIEF DESCRIPTION OF THE DRAWINGS

FIG. 1 shows the basic configuration of an embodiment of the present invention;

FIG. 2 shows the configuration of the variable filter means shown in FIG. 1;

FIG. 3 shows the entire configuration of an embodiment of the present invention;

FIG. 4 is an explanatory view of the operations of the SW shown in FIG. 3;

FIG. 5 is an explanatory view of the operations of the SW shown in FIG. 3;

FIG. 6 shows the configuration of a variable BPF;

FIG. 7 shows the configuration of a variable HPF;

FIG. 8 shows the configuration of a variable all pass filter;

FIG. 9 is an explanatory view of the characteristic of the variable BPF;

FIG. 10 is an explanatory view of the characteristic of the variable HPF;

FIG. 11 is an explanatory view of the characteristic of a variable all pass filter; and

FIG. 12 is a block diagram of the configuration of the related technology.

### DESCRIPTION OF THE PREFERRED EMBODIMENT

The embodiments of the present invention are described below by referring to the attached drawings.

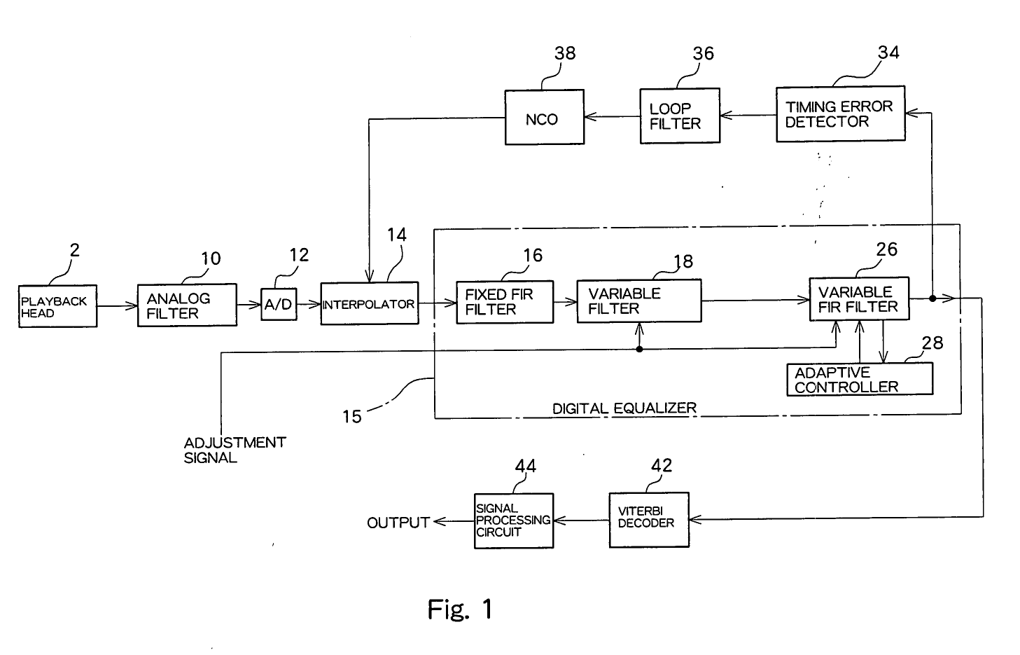

First, to explain the configuration of the data regeneration apparatus according to the present embodiment, the basic configuration is explained. FIG. 1 is a block diagram of the basic configuration of the data regeneration apparatus. A playback head 2 regenerates digital data recorded on a magnetic tape, etc., an amplifier amplifies the data, and outputs the data to an analog filter 10.

The analog filter 10 is an antialiasing filter, and cuts fb/2 (fb indicates a bit rate) or more of the frequency component of an analog signal, and outputs the result to an A/D 12.

The A/D 12 converts an analog signal from the analog filter 10 to a digital signal, and outputs the signal to an interpolator 14. Practically, the A/D 12 samples an analog signal according to the clock from the PLL not shown in the attached drawings, quantizes a sample of plural bits, and digitizes it.

Based on the digital signal from the A/D 12, the interpolator 14 estimates symbol point data between the sample point data and the sample. Since the A/D 12 samples data not in synchronization with a symbol (asynchronous sample) according to the clock from the PLL, it is necessary for the interpolator 14 to interpolate the symbol point data. The interpolator 14 resamples the data interpolated for the sample data of the A/D 12. The interpolator 14 is basically configured by a FIR filter. The interpolator 14 is configured by including a plurality of latches serially connected to each other, a plurality of coefficient units, and adders. Each latch holds a digital signal for a sampling period, and then outputs it. Each coefficient unit multiplies an input digital signal by a predetermined coefficient, and outputs a result to an adder. The adder adds the output of each coefficient unit, and outputs the result to a digital equalizer at a subsequent stage. The coefficient of each coefficient unit is predetermined in a coefficient set. Plural sets (for example, 32) of coefficient sets are prepared, and any of them is selected. That is, depending on the interpolation position, a set of the plurality of sets is selectively used. The interpolation, that is, the interpolation timing, is adjusted by a timing control circuit comprising a timing error detector 34, a loop filter 36, and an NCO (numerically controlled oscillator).

When a digital signal is interpolated by the interpolator 14 and resampled, it is provided to a digital equalizer 15 where it is subjected to an equalizing process.

The digital equalizer 15 controls the amplitude of a digital signal and a group delay to match a digital signal with a desired target characteristic. In the present embodiment, the equalizing process is performed on a digital signal. The digital equalizer 15 is practically configured by comprising a fixed FIR filter 16, a variable filter 18, a variable FIR filter 26, and an adaptive controller 28.

The fixed FIR filter 16 compensates for the degradation of the high frequency component of a digital signal from the interpolator 14 by boosting the high frequency component. That is, since the high frequency component of an original signal is degraded by each filter of the playback head 2, the analog filter 10, and the interpolator 14, the high frequency component is boosted by a predetermined value (fixed value).

The variable filter 18 variably controls the amplitude and group delay of a digital signal from the fixed FIR filter 16. For example, when it is configured by a plurality of latches and coefficient units, the coefficient (tap coefficient) of a coefficient unit is variable.

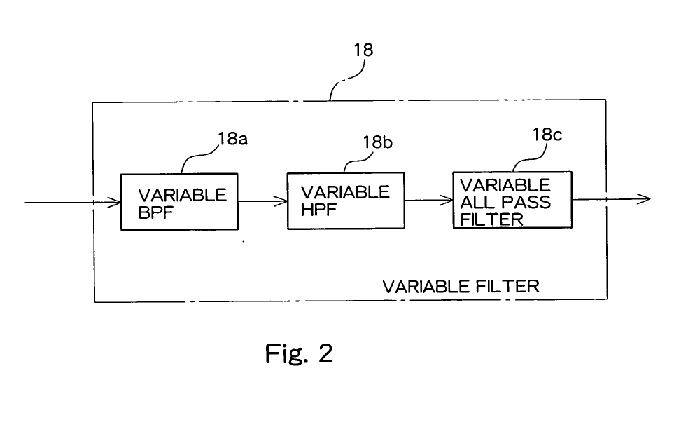

FIG. 2 shows an example of a configuration of the variable filter 18. The variable filter 18 is configured by a variable band pass filter (BPF) 18a, a variable high pass filter (HPF) 18b, and a variable all pass filter 18c. The variable BPF 18a and the variable HPF 18b adjust the amplitude of a digital signal, and the variable all pass filter 18c controls the group delay of the digital signal. The tap coefficient of each filter is variably adjusted by an external adjustment signal. Practically, the coefficient data value of each coefficient unit is written to the register not shown in the attached drawings, and the register value is provided for each filter. The digital signal whose amplitude and group delay are adjusted by the variable filter 18 is provided for the variable FIR filter 26.

Returning to FIG. 1, the variable FIR filter 26 is an FIR filter for matching the characteristic of an input digital signal with a target characteristic, and has a variable coefficient of a coefficient unit. The variable coefficient of a coefficient unit is adjusted and set using the adjustment signal from the adaptive controller 28. The adaptive controller 28 calculates the difference between the target characteristic (provisionally determined target characteristic) and the characteristic of an input digital signal. Depending on the difference and according to a predetermined algorithm, the coefficient of the FIR filter is increased and adjusted. For more details, the adaptive controller 28 comprises a determiner, subtractor, and an adaptive algorithm processor. The determiner compares the output of the variable FIR filter 26 with a threshold, and determines which of the digital values the output digital value indicates (when a predetermined digital value is 0, −1, or +1, the output digital value is compared with a threshold to determine which is the value). For example, when the output digital value from the variable FIR filter 26 is 0.8, the determiner determines it to be +1, and the value is output to the subtractor.

The subtractor subtracts the output from the variable FIR filter 26 and a determination result from the determiner, and calculates the difference. The difference indicates the difference between the characteristic of an input digital signal and a target characteristic. The subtractor outputs the difference to an adaptive algorithm processor. The adaptive algorithm processor repeatedly changes the tap coefficient of the variable FIR filter 26 to meet the LMS (least mean square) algorithm, that is, to minimize the square of the difference (error signal). The adaptive algorithm processor is configured by a circuit, but can program a DSP and process it as software. As described above, an input digital signal can be quickly equalized and converged to a target characteristic (target PR4 characteristic). The variable filter 18 can roughly adjust the amplitude and group delay of the digital signal characteristic, and the variable FIR filter 26 can precisely adjust the group delay of the digital signal characteristic to match it with the target characteristic.

The digital signal finally equalized by the variable FIR filter 26 is provided to a Viterbi decoder 42. The Viterbi decoder 42 detects a digital signal based on the Viterbi algorithm, and outputs it to a signal processing circuit 44. The signal processing circuit 44 obtains a regenerated video signal and a regenerated audio signal according to the digital signal obtained by the Viterbi decoder 42, and outputs the signal to a monitor or other devices.

The output of the variable FIR filter 26 is also provided for the timing error detector 34, provided for a number control oscillator (NCO) 38 through the loop filter 36, generates a control signal depending on the timing error by the NCO 38, provides the result to the interpolator 14 for timing adjustment. According to the control signal from the NCO 38, the interpolator 14 interpolates a set depending on the control signal from a plurality of sets of coefficients of the coefficient unit as described above, and optimizes the interpolation timing (establishes synchronization).

Thus, in the data regeneration apparatus shown in FIG. 1, the digital equalizer 15 equalizes the digital signal from the interpolator 14, and the filter configuring the digital equalizer 15 is a variable filter (whose characteristics can be adjusted) thereby flexibly and precisely compensating for the characteristic variance of a magnetic tape, etc. recording digital data, the characteristic variance of a playback head, the characteristic variance of the analog filter 10, etc.

On the other hand, when the filter characteristic of a variable filter is adjusted, the input of the timing control system comprising the timing error detector 34, the loop filter 36, and the NCO 38 is also changed. Therefore, temporarily obtained synchronization can be changed. Originally, the synchronization and filter characteristic were to be individually adjusted, and the filter characteristic optimized based on the establishment of the synchronization.

Therefore, according to the present invention, based on the basic configuration shown in FIG. 1, a further new configuration is added to solve the above-mentioned problem.

FIG. 3 shows the entire configuration of the data regeneration apparatus according to the present embodiment. The difference from the configuration shown in FIG. 1 is that, in addition to the variable filter 18 forming the digital equalizer 15, a variable filter 19 is provided, the variable filter 18 is connected parallel to the variable filter 19, and a switch SW is provided for selectively switching between the signal system of the variable filter 18 (system of the variable filter 18 and the variable FIR filter 26) and the signal system of the variable filter 19, and outputting the switching result to the timing error detector 34.

The variable filter 19 can variably adjust the variable filter and the filter characteristics, and the configuration is the same as the variable filter 18. Therefore, the variable filter 19 also comprises a variable BPF, a variable HPF, and an all pass filter as with the variable filter 18 shown in FIG. 2. The coefficient (tap coefficient) of the variable filter 19 is also variably set by an external adjustment signal as with the variable filter 18.

The variable filter 18 and the variable filter 19 are set to have appropriate filter characteristics by an external adjustment signal. When it is necessary for the digital equalizer 15 to adjust the equalization characteristic due to the characteristic variance of a record medium characteristic of a magnetic tape, etc., only the filter characteristic of the variable filter 18 is changed and adjusted, and the filter characteristic of the variable filter 19 is maintained.

The switch SW selectively switches between a contact a (variable filter 19 side) and a contact b (variable filter 18 side). The switching operation of the switch SW is performed by the trigger, that is, the completion of the variable adjustment by the variable filter 18. In FIG. 3, the switch signal provided for the SW is provided for the SW using the end of the variable adjustment as a trigger, and contacts of the SW are switched. Assume that the contact of the SW is on the contact a, the timing control is performed based on the output of the variable filter 19. Assume that the contact of the SW is on the contact b, the timing control is performed based on the output of the variable filter 18 (and variable FIR filter 26).

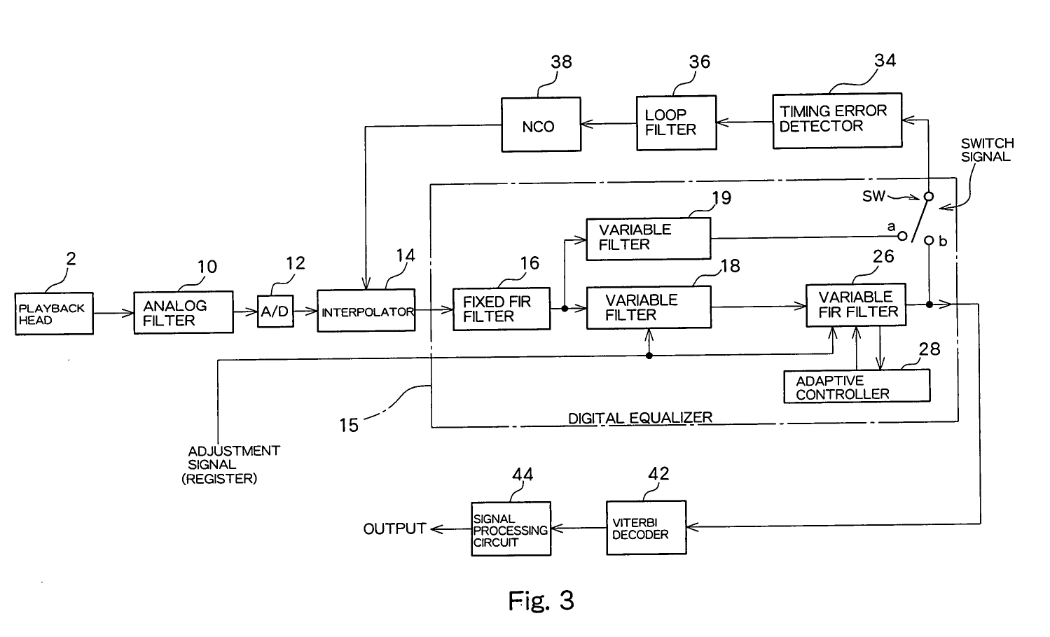

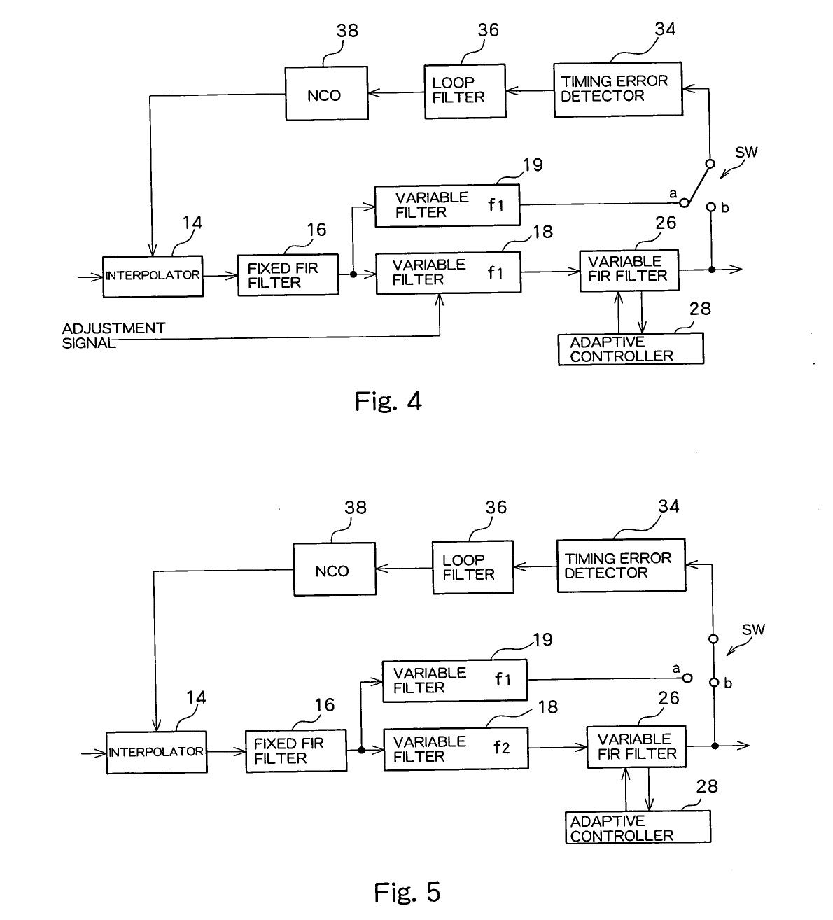

The switching operation of the SW is explained by referring to FIGS. 4 and 5.

FIGS. 4 and 5 show the important portion shown in FIG. 3. As shown in FIG. 4, the SW is first set on the contact a, the result from the variable filter 19 is output to the timing error detector 34, and the timing feedback control is performed by the output of the variable filter 19, thereby establishing the synchronization. In the state when it is necessary for the digital equalizer 15 to change and adjust the equalization characteristic due to the characteristic variance of the record medium such as a record medium, etc., only the filter characteristic (tap coefficient of the coefficient unit) of the variable filter 18 is changed, and the filter characteristic (tap coefficient of a coefficient unit) of the variable filter 19 is maintained. The filter characteristic of the variable filter 19 is not changed, but is maintained as is. Therefore, the signal to be provided to the timing error detector 34 indicates no change, and the interpolation timing in the interpolator 14 can also be maintained.

When the adjustment of the variable filter 18 is completed, that is, the target characteristics of the variable filter 18 and the variable FIR filter 26 substantially match the target characteristic, the coefficient of the variable filter 18 is set to the value after the adjustment. Additionally, as shown in FIG. 5, the contact of the SW is switched from the contact a to the contact b. As a result, the output of the filter characteristic adjusted variable filter 18 is provided to the timing error detector 34, and the synchronization is newly established by the output of the variable filter 18.

When the coefficient adjustment of the variable filter 18 is completed, the coefficient substantially converges into a constant value. Therefore, it is detected and the switch signal is output to the SW to switch the contact of the SW from the contact a to the contact b.

Thus, according to the present invention, the variable filter 18 and the variable filter 19 are connected parallel to each other, and the variable filter for establishing synchronization and the variable filter for change of a filter characteristic are independently arranged. As a result, in the state with synchronization established, only the filter characteristic can be changed, thereby easily adjusting the filter characteristic.

According to the present embodiment, the variable filter 19 is provided parallel to the variable filter 18, but in addition to the variable filter 19, a variable FIR filter can also be provided at the subsequent stage of the variable filter 19. The switch SW selectively outputs the output of the variable FIR filter provided at the subsequent stage of the variable filter 19 or the output of the variable FIR filter 26 at the subsequent stage of the variable filter 18 to the timing error detector 34. During the adjustment of the filter characteristic, the synchronization is established according to the digital signal equalized by the variable FIR filter provided at the subsequent stage of the variable filter 19, and after the adjustment of the filter characteristic of the variable filter 18, the synchronization is established at the output of the variable FIR filter 26.

The configuration of the variable filter 18 and the variable filter 19 according to the present embodiment is arbitrarily determined, but examples are listed below.

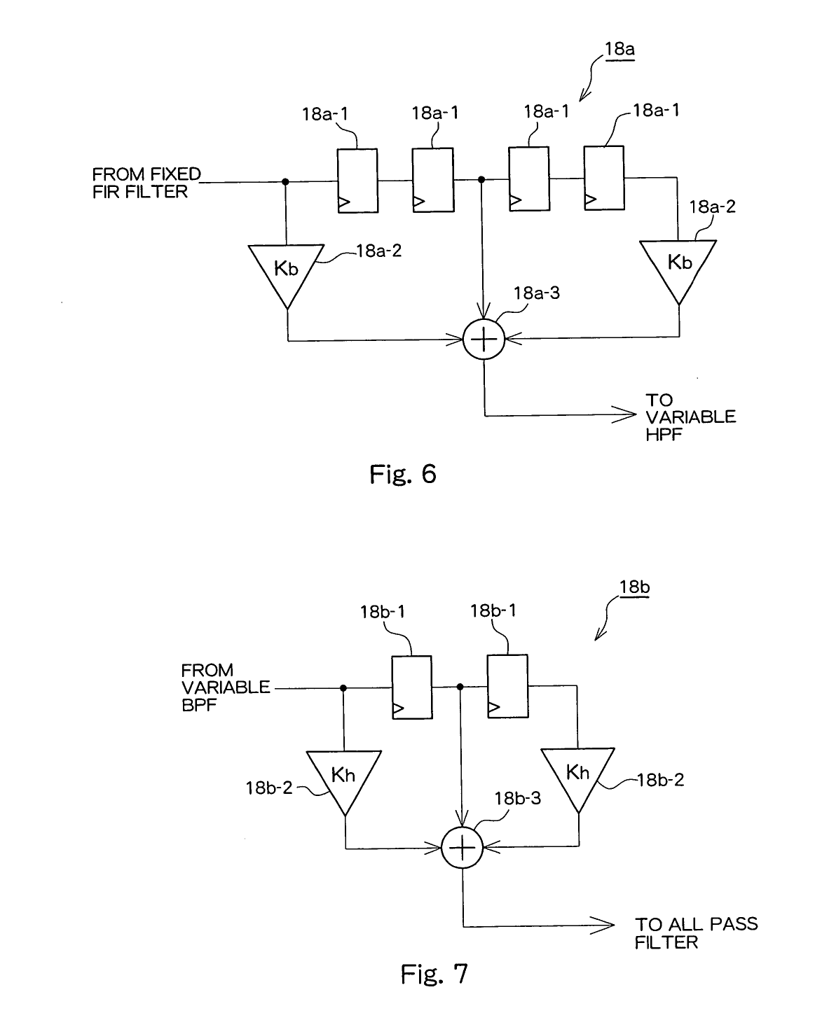

FIG. 6 shows the configuration of the variable BPF 18a. The variable BPF 18a comprises: a plurality of (4 in FIG. 6) latches 18a-1 connected in series; a plurality of (2 in FIG. 6) coefficient units 18a-2 connected in parallel; and adders 18a-3. The output of the fixed FIR filter 16 is provided to the latch 18a-1, and the coefficient unit 18a-2. The coefficient unit 18a-2 multiplies the digital signal by a variable coefficient Kb, and outputs the result to the adder 18a-3. The latch 18a-1 holds a digital signal, and outputs it to the adder 18a-3. A digital signal which passes through a plurality of latches 18a-1 is provided to another coefficient unit 18a-2. The other coefficient unit 18a-2 multiplies the input digital signal by the variable coefficient Kb, and outputs the result to the adder 18a-3. The adder 18a-3 adds up these signals, and outputs the result to the variable HPF 18b at the next stage. By appropriately adjusting the variable coefficient Kb in the coefficient unit 18a-2, the filter characteristic of the BPF changes.

FIG. 7 shows the configuration of the variable HPF 18b comprising a plurality of (2 in FIG. 7) latches 18b-1, a plurality of (2 in FIG. 7) coefficients unit 18b-2, and adder 18b-3. The digital signal from the variable BPF 18a is provided to the latch 18b-1 and the coefficient unit 18b-2. The coefficient unit 18b-2 multiplies the digital signal by the variable coefficient Kh, and outputs the result to the adder 18b-3. The latch 18b-1 holds the digital signal, and then outputs it to the adder 18b-3. The digital signal passes through the two latches 18b-1 and is transmitted to another coefficient unit 18b-2, and the other coefficient unit 18b-2 multiplies the input digital-signal by the variable coefficient Kh, and outputs the result to the adder 18b-3. The adder 18b-3 adds up these signals, and outputs the result to the variable all pass filter 18c at the next stage. By appropriately adjusting the variable coefficient Kh in the coefficient unit 18b-2, the filter characteristic of the HPF changes.

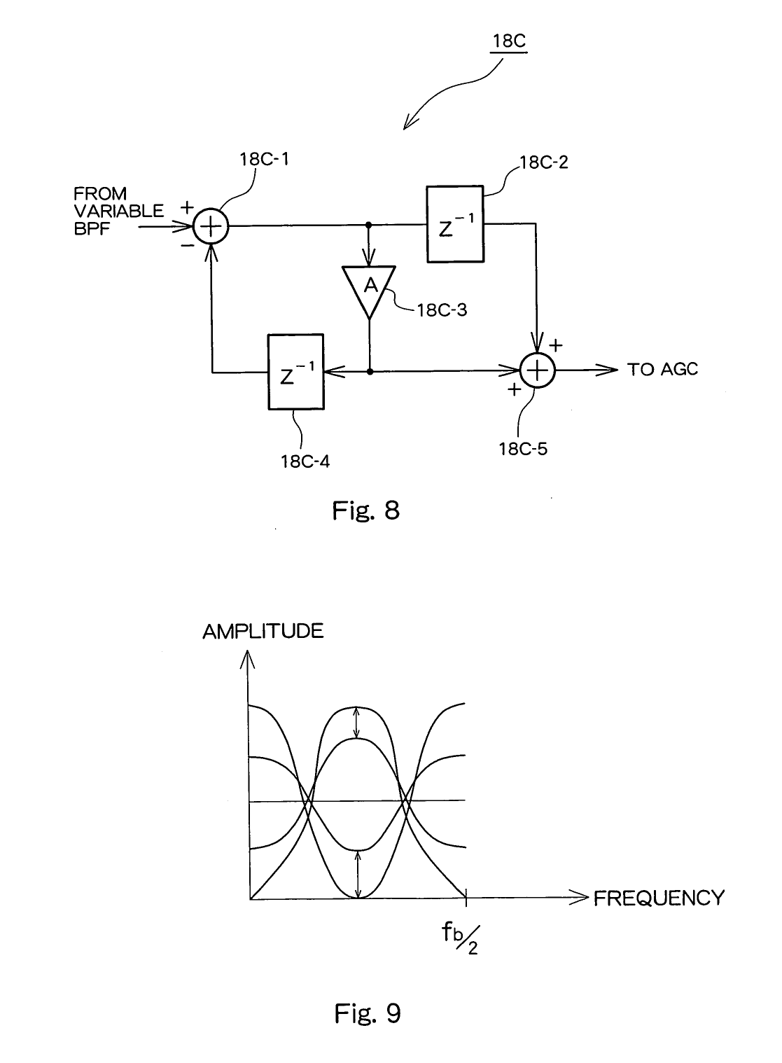

FIG. 8 shows the configuration of the variable all pass filter 18c. The variable all pass filter 18c comprises a subtractor 18c-1, a delay unit 18c-2, 18c-4, a coefficient unit 18c-3, and an adder 18c-5. The digital signal from the variable BPF 18b is provided to the subtractor 18c-1. The subtractor 18c-1 calculates the difference between the input digital signal and the delay digital signal from the 18c-4, and outputs the results to the coefficient unit 18c-3 and the delay unit 18c-2. The coefficient unit 18c-3 multiplies the differential signal by the variable coefficient A, and outputs the result to the adder 18c-5 and delay unit 18c-4. The delay unit 18c-4 delays the difference signal by 1 sample, and provides the result to the subtractor 18c-1. The adder 18c-5 adds the signal from the delay unit 18c-2 and the signal from the coefficient unit 18c-3, and outputs them. The subtractor 18c-1, coefficient unit 18c-3, and delay unit 18c-4 constitute the IIR filter, the coefficient unit 18c-3, the delay unit 18c-2, and the adder 18c-5 form the FIR filter, and the group delay is controlled by adjusting the coefficient A of the coefficient unit 18c-3. By setting a negative value for the coefficient A of the coefficient unit 18c-3, the group delay amount of the low frequency component of an input digital signal increases, and by increasing the value of the coefficient A, the delay amount can be varied.

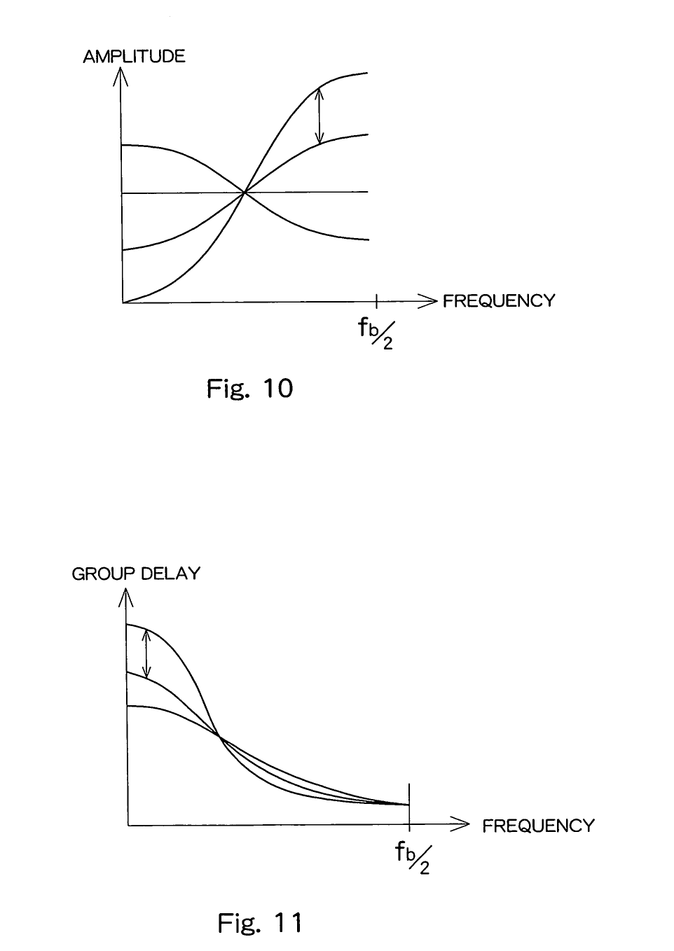

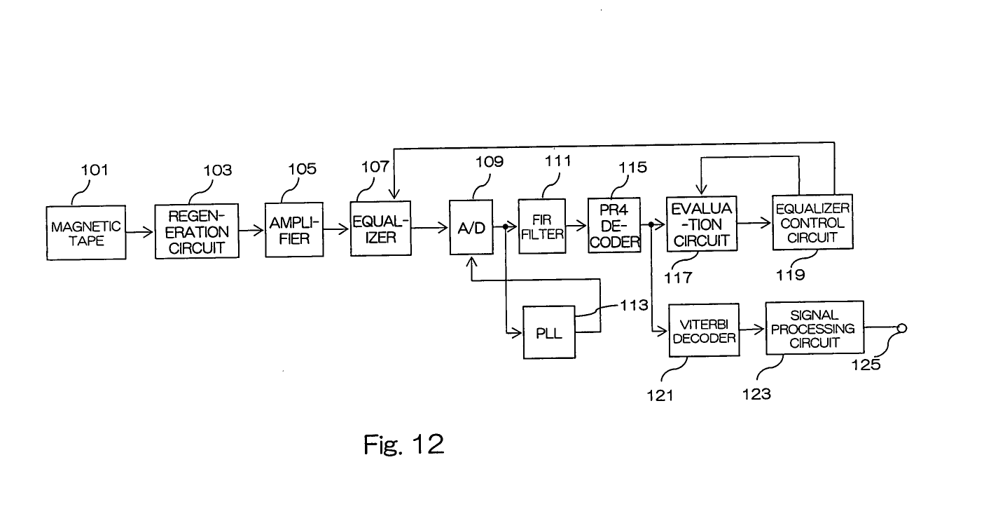

FIGS. 9 to 11 show the characteristic of each filter. FIG. 9 shows the characteristic of the variable BPF 18a. FIG. 10 shows the characteristic of the variable HPF 18b. FIG. 11 shows the characteristic of the variable all pass filter 18c. In each figure, an arrow indicates the characteristic change obtained by changing the coefficient (tap coefficient) of a coefficient unit. “fb” indicates a bit rate.

As explained above, in the present embodiment, an equalizer is formed by a digital filter which can be a variable filter, and as a result adjustments can be made depending on the characteristic variance of a record medium, a playback head, etc. flexibly and with high precision for each equalization characteristic.

According to the present embodiment, a plurality of variable filters (2 in the present embodiment) can be provided parallel to each other with a coefficient of one variable filter adjusted while timing control is performed using the output of the other variable filter. As a result, the timing control and the filter characteristic control can be individually performed, and the adjustments can be completed quickly.

As described above, the embodiment of the present invention is explained. But the present invention is not limited to this application, and many variations can be realized.

For example, in the present embodiment, an automatic gain controller (AGC) is provided between the variable filter 18 and the variable FIR filter 26. The output gain of the variable filter 18 is adjusted, and the variable FIR filter 26 can be provided. The gain adjustment is practically feedback controlled as in the timing control, the output of the digital equalizer 15 is provided to the gain error detector, and the AGC is controlled through the loop filter. Originally, the switch SW is switched to the contact a. Therefore, the output of the variable filter 19 is provided to the gain error detector for gain control, and after the filter characteristic adjustment of the variable filter 18, the switch SW is switched to the contact b. Therefore, the output of the variable filter 18 (variable FIR filter 26) is provided to the gain error detector, and the gain control is performed.

The data regeneration apparatus according to the present invention can be incorporated into the regeneration apparatus of a DVC (digital video camera), a HDD (hard disk drive), CD drive, DVD drive. The digital data such as PR4, etc. is regenerated by the playback head as an analog signal, and the analog regeneration signal is digitized and regenerated for application to any device.

1. A data regeneration apparatus, comprising:
regeneration means for regenerating digital data;
analog-to-digital conversion means for converting an analog signal from the regeneration means to a digital signal;
interpolation means for interpolating a digital signal from the analog-to-digital conversion means;
digital equalization means for equalizing a digital signal from the interpolation means to a desired target characteristic; and
timing adjustment means for adjusting interpolation timing in the interpolation means according to the digital signal from the digital equalization means, wherein
the digital equalization means comprises:
a plurality of variable filter means connected parallel to each other, and
switch means for selectively switching and outputting the output of the plurality of variable filter means to the timing adjustment means.

2. The apparatus according to claim 1, wherein
the plurality of variable filter means include a first variable filter and a second variable filter; and
the switch means outputs the output of the first variable filter to the timing adjustment means while the second variable filter is being filter characteristic adjusted, and outputs the output of the second variable filter to the timing adjustment means after the filter characteristic adjustment of the second variable filter is completed.

3. The apparatus according to claim 1, wherein
the plurality of variable filter means comprise:
a variable filter for adjusting the amplitude of an input digital signal; and
a variable all pass filter for adjusting a group delay of a digital signal from the variable filter.

4. The apparatus according to claim 1, wherein
the digital data is PR4-precoded digital data.
